(19) United States
(12) Patent Application Publication
(10) Pub. No.: US 2019/0280770 A1
(43) Pub. Date: Sep. 12, 2019

(54) METHOD AND APPARATUS FOR FREE-SPACE OPTICAL TRANSMISSION

(71) Applicant: QINETIQ LIMITED, Farnborough, Hampshire (GB)

(72) Inventor: Robert Francis Sean HICKS, Farnborough (GB)

(73) Assignee: QINETIQ LIMITED, Farnborough, Hampshire (GB)

(21) Appl. No.: 16/345,059

(22) PCT Filed: Oct. 19, 2017
(86) PCT No.: PCT/EP2017/076748

§ 371 Date: Apr. 25, 2019

(30) Foreign Application Priority Data
Nov. 2, 2016 (GB) 1618501.9

(51) Int. Cl. H04B 10/116

(52) U.S. Cl. CPC H04B 10/116; H04N 5/374

(57) ABSTRACT

Methods and apparatus for determining a data signal. In an example, a method includes acquiring at least one image of a field of view at a first frame rate and identifying a sub-region of the field of view, wherein the sub-region contains an optical data signal. A plurality of images of the sub-region of the field of view may be acquired at a second frame rate, wherein the second frame rate is higher than the first frame rate, and a data signal encoded in the optical data signal may be determined from the plurality of images of the sub-region of the field of view.

This invention relates to detecting and/or transmitting optical data signals. In some examples, optical data signals may be detected from a series of images.

Free-space optical communication is a wireless communication method which uses optical radiation propagating in free space (rather than, for example, an optical fibre or a waveguide) to transmit data. An optical source, such as a laser or LED, transmits optical radiation which propagates through air, or another medium, and may be received at a receiver. As used herein, the term ‘optical radiation’ includes electromagnetic radiation from the far infra-red, through the visible, to the far ultraviolet portion of the electromagnetic spectrum. The maximum distances between transmitter and receiver, and the data transmission rate which can be achieved vary depending on the details of the system, but may be up to several kilometres and several Gbit/s.

So-called ‘Li-Fi’ is an example of a multidirectional optical communication method. Light sources such as LEDs may be used to provide a means of communicating by switching the LEDs on and off at a rate which is higher than is visible to the human eye. A receiving device detects the rapidly switching light and decodes the signal.

Many wireless communications systems are directional and require the transmitter and receiver to be configured in particular directions relative to each other. An advantage of systems such as Li-Fi is that the transmitter may be non-directional and does not need to be oriented in a particular direction with respect to the receiver.

Optical communication may be useful when communicating by radio waves or micro waves is not possible or undesirable, for example if there is interference present. In some cases, radio networks may be detectable using, for example, frequency scanners, but optical networks may escape detection by such means.

In some examples, devices may be connected to the internet to enable the remote control thereof. However, this can make them vulnerable to remote attack or hijack. An optical communication network may be limited to ‘line of sight’ and therefore in some examples may be less vulnerable to remote attack.

### SUMMARY OF THE INVENTION

According to a first aspect of the invention, a method of determining a data signal comprises:
(i) acquiring at least one image of a field of view at a first frame rate;
(ii) identifying a sub-region of the field of view, wherein the sub-region contains an optical data signal;
(iii) acquiring a plurality of images of the sub-region of the field of view at a second frame rate, wherein the second frame rate is higher than the first frame rate; and
(iv) determining a data signal encoded in the optical data signal from a plurality of images of the sub-region of the field of view.

When capturing and processing images, there is a processing burden associated with the size of the image, which in some examples may be quantified in terms of pixels, and the processing burden may increase with image size and frame rate (i.e. the number of images read from an imaging apparatus per unit time). Either or both frame rate and image size may be limited by the processing power available at a particular apparatus. When acquiring a data signal contained within an optical data transmission, the data rate of the signal may be limited by the frame rate of image capture—for example, a signal which changes faster than images are captured may not be correctly read from the images.

In this example, a first stage of the method may detect the presence of an optical data signal in a field of view at a slower frame rate, and then a second stage may determine the data content of the optical data signal from images acquired at a faster frame rate, but only considering a sub-region of the field of view. Thus there are two modes, in which the demands on the processing resources are traded off in different manners: for example, in a first mode, the number of pixels per frame may be higher and the number of frames per unit time lower than in the second mode.

By restricting the field of view to just a sub-region in order to determine the data content of the optical data signal, the frame rate may be increased and therefore the data rate of data transmission may also be increased. By having a relatively large field of view when detecting the presence of an optical data signal, optical data signal(s) may be detected over a relatively large area.

The identified sub-region may for example comprise all imaging pixels in an imaging field of view which may contain the optical data signal. In some examples, the sub-region may be a sector of the field of view which includes the optical data signal, or may comprise a region which encloses the portion of the field of view which contains the optical data signal, where the region is of a predetermined size. The size of the sub-region may in some examples be selected based at least in part on available hardware resources (e.g. processing and memory resources) to process the data contained therein. Therefore, in some examples, the size of the sub-region may be determined bearing in mind any limitations on such resources. In some examples, a sub-region may move within the field of view, for example having a trajectory there through.

In some examples, the steps may be carried out in the order stated and/or the optical data signal may be a free-space optical signal.

In some examples, the method may comprise acquiring a plurality of images of the field of view at the first frame rate, and identifying the sub-region of the field of view may comprise identifying, from the plurality of images, a region of the images containing an optical data signal having a signal transmission period and a non-transmission period.

In such examples the transmission and non-transmission periods may assist in identifying the optical data signal as the signal of interest with relative ease. For example, this may allow a signal to be more readily distinguished from an image background. In some examples, the signal transmission period and a non-transmission period may have a predetermined and/or characteristic cycle and identifying the sub-region may comprise identifying a signal having that predetermined and/or characteristic cycle.

In examples in which a signal comprising transmission period and a non-transmission period is identified, identifying the sub-region of the field of view may comprise comparing an intensity of a first set of one or more images to an intensity of a second set of one or more images, and identifying a region of the image(s) in which an intensity change exceeds a predetermined threshold. By comparing images in this way, the effect of the background is effectively negated.

For example, a comparison may be carried out a pixel-by-pixel basis. The intensity of a pixel in a first image may be compared to the intensity of a corresponding (i.e. relating to the same region of a captured field of view) pixel in a second image. In other examples, the average intensity of one or more corresponding pixels from a first set of images may be compared to the average intensity of the same corresponding set of pixels from a second set of images. By comparing average intensity from multiple images, it is possible to reduce the noise and improve detection of a signal of interest.

In other examples, the optical data signal may be modulated in some other manner, for example dimming, changing frequency, or the like. Any modulation pattern may assist in distinguishing the signal from the background.

In some examples determining the data signal comprises detecting data encoded using binary on-off keying. This provides a simple method for encoding and transmitting signals. In other examples, the optical data signal may be encoded using some other modulation, for example a frequency modulation, a pulse width modulation, an amplitude modulation or the like. The frequency of modulation for encoding the data may be higher than the frequency of any modulation applied to assist in distinguishing the optical data signal from the background. The frequency of modulation for encoding the data may be such that it may be detected by acquiring images at the second frame rate and the frequency of any modulation applied to assist in distinguishing the optical data signal may be such that it may be detected by acquiring images at the first frame rate.

In some examples the method may comprise identifying a plurality of sub-regions of the field of view, each of the sub-regions containing an optical data signal; acquiring a plurality of images of the sub-regions at a second frame rate and determining the data signals encoded in the optical data signals from the plurality of images of the sub-regions. Each sub-region and data signal may be determined in any manner set out above for a single sub-region. While the optical data signals may have different characteristics (for example, different frequencies, different transmission cycles, or the like), they may also have common characteristics and may be spaced from one another in the field of view. This allows detection of multiple optical data signals of interest. Each optical data signal may be identified and sub-regions assigned so that in each sub-region there is an optical data signal. In some examples there may be one or more optical data signals within a sub-region.

In some examples the method comprises determining a bearing to an optical data signal transmission source. In some examples, the location of the optical data signal transmission source within the field of view may be determined to identify the relevant sub-region. The location of the optical data signal transmission source also provides information about the relative direction of the source and thus in some examples allows the bearing to the optical data signal transmission source to be calculated. This may provide navigational information (for example the optical data signal transmission source may be provided as a way marker, or the like) or tracking information (for example, the optical data signal transmission source may be mounted on mobile apparatus, which may be tracked in space). In other examples, the bearing may be used to identify (or assist in identifying) an optical data signal transmission source or apparatus associated therewith, wherein the source/apparatus may be have a known location. In some examples, a receiving unit may calculate its own absolute location based on the measured relative bearing to a source where the source is communicating its absolute location. In some examples, a receiving unit may be incorporated into autonomous system's vision system, in which case the understanding of the optical data signal transmission source location (bearing) may be linked to the autonomous system's spatial understanding and may aid an understanding of what object is transmitting the data signal.

In some examples the first frame rate is in a range between approximately 10 to 60 fps (frames per second) and/or the second frame rate is in a range between approximately 1000 to 20,000 fps. Such frame rates are achievable by a range of receiving apparatus.

In some examples the frame rates achievable may be limited by the processing speed or the exposure time of the imaging sensor used. Frame rates of 30 frames per second are typical of a standard imaging sensor operating at a standard video frame rate. Higher frame rates may require significant processing resources, but the processing resources may be reduced by reducing image size, for example if a number of pixels read out from an image sensor is decreased. By selecting a sub-region of the field of view, a higher frame rate may be achieved with a given amount of processing resource.

In some examples the method further comprises the step of transmitting a data signal from an optical data transmission source. Transmitting the data signal may comprise applying a modulation thereto. In some examples, transmitting the optical data signal comprises transmitting an optical signal having a first modulation at a predetermined first temporal frequency and the data is encoded in a second modulation of the optical signal, the second modulation having a predetermined second temporal frequency which is higher than the first temporal frequency. The first modulation may assist in detecting the presence of the optical signal at the first frame rate. In some examples, the method may comprise transmitting data in a series of signal transmission periods separated by non-transmission periods, wherein the signal transmission periods occur at the predetermined first temporal frequency and the data transmitted in each transmission period is transmitted at the predetermined second temporal frequency and is encoded as a series of optical pulses. As noted above, by modulating the signal (in some examples according to a characteristic cycle), it may be easier to distinguish the signal from the background. The first and second temporal frequencies may be determined based on a predetermined or anticipated first and second frame rate, or the first and second frame rates may be determined based on a predetermined or anticipated first and second temporal frequencies. The data transmitted may be transmitted repeatedly over two or more cycles.

In some examples, the predetermined first temporal frequency is between approximately 0.4 Hz and 4 Hz and/or the second predetermined temporal frequency is between approximately 1 kHz and 10 kHz. Such temporal frequencies may be detectable with a first frame rate of about 24 to 60 fps and a second frame rate of around 1500-10,000 fps. Moreover light sources which may be modulated at such rates, for example, Light Emitting Diodes (LEDs), are readily available.

At least some steps of the first aspect of the invention may be executed by a general purpose computer, a special purpose computer, an embedded processor or processors of other programmable data processing devices to realize the functions described. In particular, a processor or processing apparatus may execute the machine readable instructions. The term ‘processor’ is to be interpreted broadly to include a CPU, processing unit, ASIC, logic unit, or programmable gate array etc. The functions be performed by a single processor or divided amongst several processors.

Machine readable instructions may be stored in a computer readable storage that can guide the computer or other programmable data processing devices to operate in a specific mode and may also be loaded onto a computer or other programmable data processing devices, so that the computer or other programmable data processing devices perform a series of operations to produce computer-implemented processing, thus the instructions executed on the computer or other programmable devices realise functions specified.

Further, the teachings herein may be implemented in the form of a computer software product, the computer software product being stored in a storage medium and comprising a plurality of instructions for making a computer device implement the methods recited in the examples of the present disclosure.

According to a second aspect of the invention, there is provided a receiving apparatus comprising at least one image sensor, control circuitry adapted to control a frame rate of image capture by at least one image sensor and a data processing module having a first mode of operation and a second mode of operation. In the first mode of operation, the data processing module is adapted to process image data received from at least one image sensor which is controlled to capture images at a first frame rate and to identify, within at least one image, an image sub-region as comprising an optical data transmission signal. In the second mode of operation, the data processing module is adapted to process image data relating to the image sub-region (for example, image data comprising or consisting of image data characterising to the image sub-region) received from at least one image sensor which is controlled to capture images at a second frame rate, which may be higher than the first frame rate, to determine a data content of the optical data transmission signal.

In such an apparatus, there may be a ‘trade off’ between the frame rate at which the image sensor(s) operate and the size of an image processed by the data processing module (e.g. the number of imaging pixels which are processed). For a given processing capability, by reducing an image size, the frame rate may be increased and therefore the data transfer rate of data contained within the optical data signal may also be increased.

In some examples, when operating in the second mode of operation of the data processing module, the data processing module is adapted to process an image sub-region identified in the first mode of operation and to disregard at least one other image portion. This may comprise reducing the size of each image which is processed, for example by processing a subset of the available signals output by imaging pixels.

In some examples, in the first mode of operation, the data processing module is adapted to process a plurality of images captured at the first frame rate, and to identify the image sub-region as comprising an optical data signal having a modulation, for example a signal transmission period and a non-transmission period. The modulation may have a characteristic which allows the receiving apparatus to identify the optical data signal as such. Example of such a characteristics may be the duration of a transmission period, the duration of a non-transmission period or the temporal frequency. In other examples, the optical frequency and/or modulation of a signal characteristic such as amplitude or frequency may be used to aid identification of the optical data signal within the image.

In some examples the control circuitry is adapted to control at least one image sensor to capture images at the first frame rate, and, if an image sub-region comprising an optical data transmission signal is identified, the control circuitry is adapted to control at least one image sensor to capture images at the second frame rate, wherein the second frame rate is higher than the first frame rate. In some examples, the frame rate may be adjusted such that a particular image sensor operates at the first and second frame rate in the respective modes. In other examples, different image sensors may be operated at each of the first and second frame rates. The control circuitry may be further adapted to control the mode of operation of the data processing module and to change the mode of operation from the first mode to the second mode if an optical data signal is detected while the data processing module is operating in the first mode.

In some examples, more than one image sensor may be provided, for example to provide different fields of view, different frame rates, different frequency bands of operation, and the like.

The image sensor(s) may be any suitable electronic imaging sensor. Suitable imagining sensors include non-line scanning image sensors, for example Complimentary Metal-Oxide Semiconductor (CMOS) imaging sensors. The image sensor(s) may be an image sensor which is able to retain or discard imaging data on a pixel-by-pixel basis, for example comprising a CMOS imaging sensor. In such a sensor, active imaging pixels may be provided, and the signals therefrom retained for processing or disregarded individually.

In some examples the data processing module is adapted to determine a bearing to a source of the optical data transmission signal.

In such examples the location of the imaging sensor may be known. The location of the optical data signal transmission source may be identified in the image frame. This allows a relative bearing from the imaging sensor to the signal transmission source to be determined, and therefore information about the location of the transmission source may be determined.

In some examples the receiving apparatus is operatively associated with an apparatus, and the control circuitry is adapted to control at least one function of the apparatus based on the optical data transmission signal. For example, the apparatus may be an “Internet of Things” device or an autonomous vehicle, or any controllable device. This may allow a control signal to be disseminated optically to such apparatus.

According to a third aspect of the invention, there is provided a transmitter comprising:

(i) an optical source for generating an optical data signal; and
(ii) a controller adapted to control the optical source to transmit an optical data signal having a first modulation at a predetermined first temporal frequency and to encode data in a second modulation of the optical signal, the second modulation having a predetermined second temporal frequency which is higher than the first temporal frequency.

In some examples, the controller may be adapted to control the optical source to transmit an optical data signal in a plurality of temporally separated transmission periods having a first predetermined temporal frequency, such that, in each transmission period, a series of optical pulses is transmitted, wherein the optical pulses encode data at a second predetermined temporal frequency.

In some examples the first predetermined temporal frequency is between approximately 0.4 Hz and 4 Hz and/or the second predetermined temporal frequency is between approximately 1 kHz and 10 kHz. These frequencies may be relatively easy to detect with readily available receiving apparatus, and provide useful data transfer rates.

For example, a typical imaging sensor may record images at frame rates of approximately 10 to 60 fps in a standard video imaging mode. Therefore an optical data signal transmitted at a frequency of between approximately 0.4 Hz and 4 Hz may be detected with such an imaging sensor. If such a sensor was to increase its frame rate to a rate of 5000 fps or higher, it may be used to detect a signal transmitted with optical pulses at a rate of around, or between, 1 kHz and 10 kHz.

The optical source may for example comprise an infrared optical source, a visible light optical source, or an ultraviolet optical source. The optical source may for example comprise an LED. The optical source may be a multi-directional (or non-directional) source which emits light over a range of angles. The data signal may be transmitted repeatedly.

According to a fourth aspect of the invention, there is provided a system comprising at least one receiving apparatus according to the second aspect of the invention and at least one optical data signal transmitter, for example a transmitter according to the third aspect of the invention.

According to a fifth aspect of the invention, there is provided an unmanned aerial vehicle comprising at least one of a receiving apparatus according to the second aspect of the invention and an optical data signal transmitter, for example a transmitter according to the third aspect of the invention.

According to a sixth aspect of the invention, there is provided an autonomous vehicle comprising at least one of a receiving apparatus according to the second aspect of the invention and an optical data signal transmitter, for example a transmitter according to the third aspect of the invention.

Features of one aspect may be included in other aspects. For example the data processing module and/or the controller may carry out method steps of the first aspect of the invention.

Embodiments of the invention are now described, by way of example only, with reference to the accompanying Figures in which:

FIG. 1 is a flow chart of a method of determining an optical data signal;

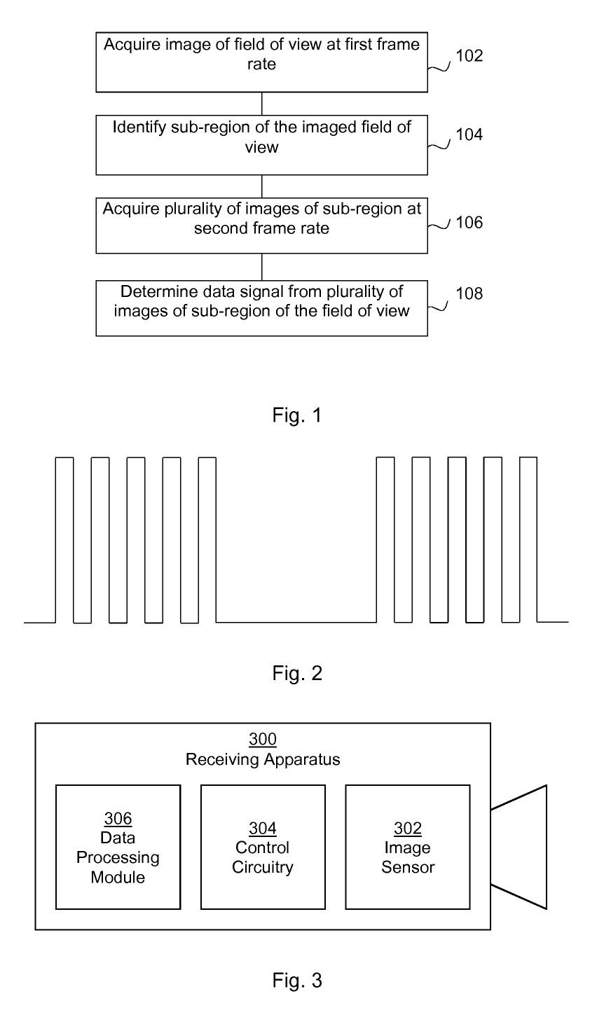

FIG. 2 shows an example of an optical data signal;

FIG. 3 shows an example of a receiving apparatus;

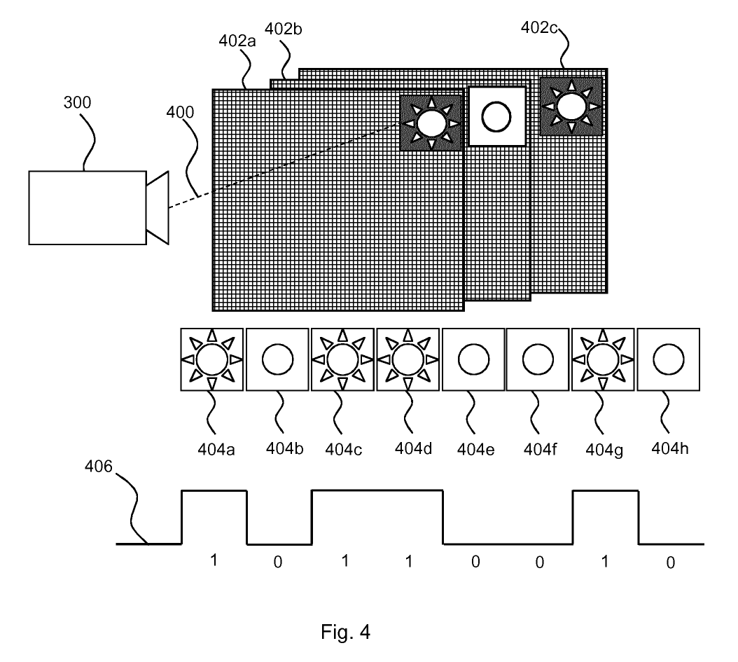

FIG. 4 shows an example of images acquired by a receiving apparatus and of the determination of a data signal therefrom;

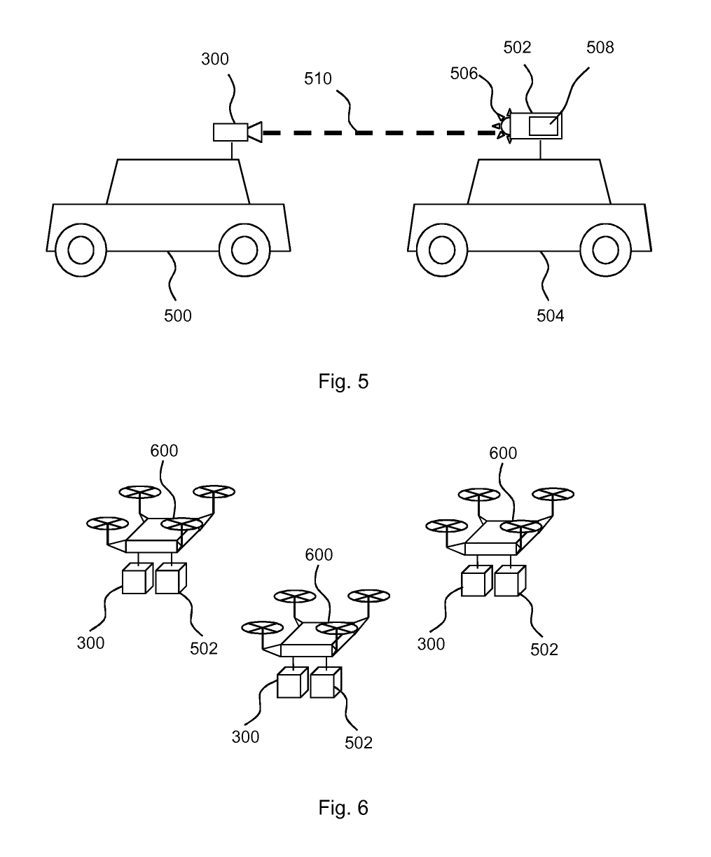

FIG. 5 shows an example of autonomous vehicles associated with receiving apparatus and transmitters; and

FIG. 6 shows an example of Unmanned Aerial Vehicles associated with receiving apparatus and transmitters.

In a first embodiment of the invention, a method of determining an optically transmitted data signal is described. The data signal in this example is provided by a pulsed light source, which operates with transmission periods in which data is transmitted and non-transmission periods.

In FIG. 1, block 102 comprises acquiring at least one image of a field of view at a first frame rate. For example, the first frame rate may be around 10, 20, 30, 40 or 50 frames per second or any video frame rate. In some examples, the frame rates may be ‘standard’ video frame rates. Such frame rates are readily achievable by a range of receiving apparatus. In some examples, the image is a digital image, for example acquired using digital receiving apparatus having an active pixel sensor, such as a Complementary metal-oxide-semiconductor (CMOS) camera. Such receiving apparatus is widely available. However, other receiving apparatus may be used, including coded aperture receiving apparatus.

In block 104, a sub-region of the imaged field of view is identified. This sub-region is identified on the basis that it contains an optical data signal. This may for example be identified as a ‘bright spot’ within the image, for example, exceeding a predetermined threshold intensity and identifying the sub-region may include identifying an image portion in which the threshold intensity is detected. Alternatively or additionally, the optical data signal may be transmitted using a particular colour of optical radiation (i.e. a particular frequency of light), which may be predetermined and identifying the sub-region may include identifying an image portion in which the color is detected. In this example, however, the method includes acquiring a plurality of images of the field of view at the first frame rate, and identifying the sub-region of the field of view comprises identifying, from the plurality of images, a region of the images containing an optical data signal having a signal transmission period and a non-transmission period.

For the sake of example, the signal transmission period and the non-transmission period may operate with a common duty cycle and a frequency of 1 Hz. In such an example, identifying the sub-region of the field of view may comprise comparing an intensity of a first set of one or more images to an intensity of a second set of one or more images, and identifying a region of the image in which an intensity change exceeds a predetermined threshold. For example, a first and second image, which were acquired half a second apart, may be compared. If any portion of the image contains the optical signal, this would be expected to be present in one of the images and absent in the other image. Therefore, one image may be ‘subtracted’ from the other, for example by subtracting the intensity of one from another on a pixel-by-pixel basis. Where there is a significant change in intensity, this may indicate the presence of a 1 Hz cycling signal transition period. If the transmission cycle is different, the temporal separation of images selected for comparison may be different.

Comparing the images in this way may reduce noise in detection. In some examples a number of images may be combined (for example, averaged) before such a subtraction. In some examples, such methods may be repeated over a number of anticipated transmission cycles, and/or it may be determined whether a detected signal is within an anticipated optical frequency band and/or originated from an expected location, or the like.

In some examples, the transmission cycle and/or optical frequency may be characteristic of a source, and/or the method may comprise detecting a plurality of such signals.

The identified sub-region may for example comprise all imaging pixels in an imaging field of view which contain the optical data signal. In some examples, the sub-region may be an image sector which includes the optical data signal, or may comprise a region which encloses the portion of the field of view which may contain the optical data signal, where region is of a predetermined size. As will be appreciated from the discussion which follows, the size of the sub-region may in some examples be selected based at least in part on available hardware resources (e.g. processing and memory resources) to process the data contained therein. Therefore, in some examples, the size of the sub-region may be determined bearing in mind any limitations on such resources.

In block 106, a plurality of images of the sub-region of the field of view are acquired at a second frame rate. The second frame rate in this example is faster than the first frame rate. For example, while the first frame rate may be a standard video frame rate of around 24 or 50 frames per second, the second frame rate may be a high frame rate, of 100, 500, 1000, 2000, 5000 or higher frames per second.

In some receiving apparatus, resource limitations mean that such high frame rates are incompatible with a high number of imaging pixels, in particular where image processing is to be carried out. To consider the example of a CMOS imager, an array of light receiving photodiodes (termed imaging pixels herein) in the imager each receives light from an associated pixel in a field of view. The light is aggregated over the ‘exposure’ time. CMOS imagers have, for each pixel, an integrated amplifier, which produces a signal which is read out into a buffer (this may be contrasted with, for example, a Charge Couple Device camera, which may typically have a single amplifier, and a single read out, for a line of imaging pixels). Therefore, the more pixels that are read, the more data which is received.

Receiving apparatus may be limited in its processing resources: detecting a data signal within the optical signal may comprise monitoring images acquired over time, and, according to embodiments of the invention, each image may be analysed to detect an optical data signal. At the time of writing, an entry level digital camera may comprise around 20 million pixels (20 Megapixels), with higher resolutions being readily available. At a frame rate of 5000 frames per second, this is a large amount of data to process, and this may be impractical in many cases.

However, in this example, only the sub-region is considered when deriving the data signal. This may for example comprise considering a rectangle having a size on the order of 1000 imaging pixels, or around 10×10, 20×20, 30×30 or 40×40 imaging pixels (or some other square or non-square rectangular region of imaging pixels). Even if considerably more pixels are considered, this may result in a significant reduction of data to process per image when compared to a full imaging pixel array.

In some examples, the sub-portion may comprise a single imaging pixel.

In some examples, the imaging data acquisition rate may be substantially similar when the whole field of view is considered as when the sub-region is considered. For example, if the first frame rate is 50 frames per second and the second frame rate is 5000 frames per second, the sub-region may correspond to around (or in some examples, at most) 1/100^{th} of the available pixels. Where more than one sub-region is identified, this consideration may apply to all sub-regions. In some examples, the size of the sub-region may be selected so as to allow, for given processing capabilities, a frame rate so as to determine a data signal having a particular data rate. In some such examples, the size of a sub-region may decrease as an actual or anticipated data rate of a received signal increases.

In other examples the maximum frame rate and size of sub-region may be determined based on the processing capability available.

While in some examples, it may be just the sub-region which is imaged, in some examples acquiring a plurality of images of the sub-region of the field of view comprises capturing a plurality of images of a field of view at the second frame rate and selecting the sub-region from the plurality of images. For example, when considering a CMOS or any ‘active pixel sensor’ imaging system, the signal collected by imaging pixels which capture the image of the sub-region may be retained (or amplified) whereas the signal from imaging pixels corresponding to image regions which are outside the sub-region may be quashed or discarded. The sub-region may be a ‘region of interest’ within the original field of view and imaging the sub-region may comprise activating a ‘region of interest’ function or mode of receiving apparatus.

In some examples, an image region outside the sub-region may be imaged at lower resolution, (for example, signals output from a set of imaging pixels may be merged in so-called ‘pixel binning’ or the signals from some pixels (e.g. alternate pixels) may be ignored in so-called ‘pixel dumping’) in order to reduce the volume of data acquired from image regions outside the sub-region.

Block 108 comprises determining the data signal encoded by the optical data signal from the plurality of images of the sub-region of the field of view. In this way, data may be extracted from the optical data signal. In this example, the data is encoded into the optical data signal using binary on-off keying. However, in other examples, this data may be encoded for example using frequency modulation, pulse width modulation, amplitude (intensity) modulation or some other encoding scheme.

The receiving apparatus used for blocks 102 and 106 may be the same, i.e. a particular receiving apparatus (for example, a digital camera) may be controlled so as to increase its frame rate and, in block 108, for example using associated processing circuitry, an imaging signal from the subset of imaging pixels which image the sub-region of the field of view may be processed. However, in other examples, different receiving apparatus may be used for blocks 102 and 106. For example, a first receiving apparatus with a slower frame rate may identify the sub-region of interest and a second receiving apparatus with a faster frame rate (and, in some examples, a smaller field of view) may capture images of the sub-region. In such examples, the fields of view may have a known relationship such that, once the sub-region has been identified within the field of view of the first receiving apparatus, it can be located by the second receiving apparatus.

In this example, as is illustrated in FIG. 2, the optical transmission comprises periods of data transmission (i.e. the data transmission periods) interspersed with periods of no transmission. The data transmitted within the data transmission periods may be encoded as a series of optical pulses, for example, if no pulse is transmitted in a window of time, this may be indicative of binary 0, whereas if a pulse is transmitted in a window, this may be indicative of binary 1 (or vice versa).

The signal transmission periods in this example occur at a predetermined first temporal frequency which may be for example between approximately 0.4 Hz and 4 Hz. A signal at such a frequency may be readily detected using ‘standard’ video frame rates of 50 frames per second and below. In some examples, the maximum value of the first temporal frequency may be determined bearing in mind the data processing resources and the frame rate achievable.

The data transmitted in each transmission period is transmitted at a predetermined second temporal frequency, for example, based on the capabilities of currently available receiving apparatus, between around approximately 1 kHz and 25 kHz. A signal at such a frequency may be detected using ‘high’ video frame rates for example capturing data at several thousand frames per second. The rate of data transfer within the optical data signal may be limited by the available frame rate given the size of a sub-region and the available processing resources. In other examples, the rate of data transfer may be limited by the exposure time of the imaging pixels (which may be, in some current examples of receiving apparatus, around 50 μs giving a top read speed of about 20 kHz).

As briefly mentioned above, in some examples, a plurality of sub-regions of the field of view may be identified, each of the sub-regions containing an optical data signal. In some examples, these may have different transmission cycles and/or optical frequencies, but these could be the same for different optical signals. In such examples, the method may include acquiring a plurality of images of the plurality sub-regions at the second frame rate; and decoding each of the data signals carried by the optical data signals from the plurality of images of the plurality of sub-regions.

In some examples, the method may include determining a bearing to an optical data signal transmission source. It will be appreciated that the location of the image to the optical data signal will be indicative of the direction of the travel of the light therefrom. Therefore, identifying the sub-region also allows a direction of a vector from the image capture device to the source of the signal to be determined. In cases where there is a direct (rather than, for example, reflected) image of the optical data signal source, this may allow the source to be located in space. In some examples, a separation distance may be determined or estimated, for example based on the intensity of the received optical signal or its size within the image.

FIG. 3 shows an example of a receiving apparatus 300 comprising an image sensor, which in this example is a CMOS digital image sensor 302, control circuitry 304 adapted to control a frame rate of image capture by the image sensor and a data processing module 306.

In some examples, the image sensor 302 may have a relatively wide field of view, such that it is able to detect an optical signal over a wide area. In other examples, there may be more than one image sensor 302, which may for example have different fields of view so as to provide for detection of an optical signal over a wider area than for a single optical imager.

The data processing module 306 has a first and a second mode of operation. In the first mode of operation, the data processing module 306 is adapted to process image data received from the image sensor 302 which is controlled to capture images at a first frame rate (as controlled by the control circuitry 304) and to identify, within at least one image, an image sub-region as comprising an optical data transmission signal. In the second mode of operation, the data processing module 306 is adapted to process image data received the from image sensor 302 which is controlled to capture images at a second frame rate to determine (i.e., acquire or decode) the data signal encoded by or on the optical data transmission signal.

In some examples, in the first mode of operation, the data processing module 306 is to process a plurality of images captured at the first frame rate, to identify the image sub-region as comprising an optical data signal having a signal transmission period and a non-transmission period, as has been described above.

In some examples, when in the second mode of operation, the data processing module 306 may process an image sub-region identified in the first mode of operation disregard at least one other image portion (in some examples, disregarding any sub-region with is outside the sub-region of interest). In other examples, such image portions may for example be processed at lower resolution.

In some examples, the control circuitry 304 is adapted to control the image sensor 302 to capture images at the first frame rate, and, if an image sub-region comprising an optical data transmission signal is identified by the data processing module 306, the control circuitry 304 is adapted to control the image sensor 302 to capture images at the second frame rate, wherein the second frame rate is higher than the first frame rate.

In embodiments where there is more than image sensor 302, it may be the case that different image sensors operate at different frame rates and/or capture different fields of view.

In some examples, as is illustrated in FIG. 4, the data processing module 306 is adapted to determine a bearing 400 to a source of the optical data transmission signal. FIG. 4 shows a receiving apparatus 300 and first series of captured images 402a-c of a field of view in which an optical data source is identified, wherein the images are captured at a first frame rate. The image is divided into a grid to represent the imaging pixels of the image sensor 302.

In the first image 402a, the optical data signal is apparent. In the second image 402b it is absent, and it reappears in the third image 402c. This may for example reflect the content of images taken at half second intervals of an optical data signal having a half second transmission period and a half second non transmission period.

Assuming that the signal is received directly (rather than being, for example reflected or refracted) or that any path changed (e.g. reflections or refractions) can be known or modelled, the direction to the source may be determined. This may allow, or assist in, identification of the source of the optical data transmission signal.

A second series of captured images 404a-h is also shown. These images 404a-h comprise just the sub-region of interest and are captured at a higher frame rate than the first series of images 402a-c, which allows the optical signal sent within the transmission period to be detected and converted to binary data 406 (which in turn may be used to decode a message).

In some examples, it may be the case that the exposure time is longer when the frame rate is slower. This may mean that the fluctuations due to encoded data within the transmission periods are effectively invisible to the receiving apparatus 300 at the first, slower, frame rate. However, in other examples, the exposure time may be the same. In such examples, there is a possibility that a captured image at the first frame rate may coincide with an ‘off’ pulse of a transmitter sent within a transmission period. In such examples, the timing of the images captured (or those images used to detect the signal) may be selected to avoid the possibility of synchronisation with the optical pulse train and/or multiple images may be acquired, to remove or reduce the risk of missed detection.

FIG. 5 shows a receiving apparatus 300 which is operatively associated with an apparatus, in this example an autonomous vehicle 500 or more specifically in this example a ‘self-driving car’. In this example a transmitter 502 is provided on a second autonomous vehicle 504, although this could for example be mounted in any way, for example in a static location, for example on a sign post.

The transmitter 502 comprises an optical source 506 for generating an optical data signal, which may be any at any optical frequency from the far infra-red to far ultraviolet. In some examples, the optical frequency may be selected to be ‘solar blind’, i.e. outside the range of frequencies which are produced by sunlight, to reduce interference. The wavelength of light used may depend on the intended use. For example, certain infrared frequencies may generally travel further in normal atmospheric conditions than optical or ultraviolet frequencies. The optical source 506 in this example is a non-directed optical source, which emits light over a wide range of angles, and this example comprises an infrared Light Emitting Diode (LED). In other example, the light source may be a laser diode, an incandescent light bulb, or any other light source capable of being modulated as described below. In some examples, the light source may be a brake light, or an indicator light, of the vehicle 504.

The transmitter 502 also comprises a controller 508 adapted to control the optical source 506 to transmit an optical data signal 510 in a plurality of temporally separated transmission periods having a first predetermined temporal frequency, such that, in each transmission period, a series of optical pulses is transmitted, wherein the optical pulses encode data at a second predetermined temporal frequency. As mentioned above, the first predetermined temporal frequency may be between approximately 0.4 Hz and 5 Hz and/or the second predetermined temporal frequency may be between approximately 1 kHz and 10 kHz, and may be selected based the available processing capabilities of an intended receiver and/or the amount of data to be transmitted. In other examples, the frequency and/or modulation of the optical source 506 may be controlled.

In an example, a communication is to be passed between the vehicles 500, 504 using the transmitter 502 to encode a message which is decoded by the receiving apparatus 300. In this example the message is a control message, which the control circuitry 304 of the receiving apparatus 300 is adapted to use to control at least one function of the vehicle 500.

In this example in each transmission period a 32 byte ASCII message is transmitted in a half-second transmission period of a 1 Hz transmission cycle (which also includes a half-second of non-transmission). 32 Bytes is equivalent to three eight character words, taken from a choice of 124 characters with one bit of error checking. This can be used for communication at rates analogous with human speech. The message may for example have an identifier, a command and a coordinate.

For example the vehicle 504 having the transmitter 502 may be a lead vehicle of a fleet. The message may for example comprise an identifier, a command such as ‘refuel’ and a coordinate, such as the coordinate of a refuelling point. In other examples, the coordinate may be a heading, and the command may be a redirect command. Other messages may be sent in this manner.

The receiving apparatus 300 identifies the portion of the field of view of the image sensor which contains an image of the transmitter 502, then increases its frame rate to acquire high frame rate video of the transmitter 502, for example at 5000 frames per second, from which the message may be decoded. The control circuitry 304 may control the vehicle 500 to insert the refuelling point as a waypoint, and, when the refuelling point is reached, may direct the vehicle accordingly.

The relative position of the receiving apparatus 300 and the transmitter 502 may be at least substantially stable during this operation. Where is this not the case, the relative speed may be known or determined and the sub-region containing the image of the transmitter 502 may change over time. In order to allow for relatively small relative movements, a sub-region may be defined to include a boundary around an initial image of the transmitter 502 such that, even in the event of relative movement, the image of the transmitter 502 may be within the boundary. In other examples, the sub-region may track the movement of the transmitter 502, for example based on a known or anticipated trajectory of the transmitter 502 through the field of view.

In this example, each of the vehicles (or other apparatus with which a receiving apparatus and/or transmitter may be associated) has just one of the receiving apparatus 300 and the transmitter 502, although in other example, one or both vehicles may have both, which may allow for bidirectional communication.

FIG. 6 shows another example in which receiving apparatus 300 and a transmitter 502 is mounted on each of a plurality, or a ‘swarm’, of Unmanned Aerial Vehicles (UAVs) 600. This may allow for coordination within the swarm. For example, a new bearing could be shared throughout the swarm optically, without risk of radio interference or the need to form a radio network (which in some examples may represent a compromise in security). Any UAV 600 could transmit or receive a command, update or other information from any other UAV 600 within its line of sight. This may for example allow a swarm to be controlled based on one or a few remote connections to receive new control instructions. It may be easier to ensure and/or secure one of a few data connection than the connections to the whole fleet, and/or may remove a requirement to provide a radio receiver and/or navigational apparatus on each UAV. It may also mean that flight plans can be restricted to just one or a few UAVs until dissemination of the information is required, without risk that radio communications may fail at the point of information dissemination.

In other examples, the receiving apparatus 300 and/or transmitter 502 may be provided on other devices, for example Internet of things' devices could communicate in this manner optically. In one example, a light source (which could also function as a light source for a room, such as a table lamp or ceiling light, or the like) may provide a command to at least one device in a room. For example, a user could indicate that they are leaving the house and the light source could encode this as a command for all applicable devices to enter a sleep state, or some other state compatible with a user being away. Such a system may be less vulnerable to remote hacking over a network. In some examples, the indication may be provided directly to the light source, for example, activating a switch thereon, or over a local area network or remotely over a wide area network.

Variations of the above embodiments may occur to the skilled person, and/or features described in relation to one embodiment may be combined with features of another embodiment.

1. A method of determining a data signal, comprising:
acquiring at least one image of a field of view at a first frame rate;
identifying a sub-region of the field of view, wherein the sub-region contains an optical data signal;
acquiring a plurality of images of the sub-region of the field of view at a second frame rate, wherein the second frame rate is higher than the first frame rate; and
determining a data signal encoded in the optical data signal from the plurality of images of the sub-region of the field of view.

2. A method according to claim 1 comprising acquiring a plurality of images of the field of view at the first frame rate, and wherein identifying the sub-region of the field of view comprises identifying, from the plurality of images, a region of the images containing a modulating optical data signal.

3. A method according to claim 2 wherein identifying the sub-region of the field of view comprises comparing an intensity of a first set of one or more images to an intensity of a second set of one or more images, and identifying a region of the image in which an intensity change exceeds a predetermined threshold.

4. A method as claimed in claim 1 wherein determining the optical data signal comprises determining a data signal encoded using binary on-off keying.

5. A method as claimed in claim 1 wherein acquiring a plurality of images of the sub-region of the field of view comprises capturing a plurality of images of a field of view at the second frame rate and selecting the sub-region from the plurality of images.

6. A method as claimed in claim 1 comprising:
identifying a plurality of sub-regions of the field of view, each of the sub-regions containing an optical data signal;
acquiring a plurality of images of the sub-regions at the second frame rate; and
determining the data signals encoded in the optical data signals from the plurality of images of the sub-regions.

7. A method as claimed in claim 1 further comprising determining a bearing to an optical data signal transmission source.

8. A method according to claim 1 wherein the first frame rate is approximately 10 to 50 frames per second and/or the second frame rate is approximately 1000 to 5000 frames per second.

9. A method according to claim 1 further comprising transmitting an optical data signal from an optical data transmission source,
wherein transmitting the optical data signal comprises transmitting an optical signal having a first modulation at a predetermined first temporal frequency and encoding the data in a second modulation of the optical signal, the second modulation having a predetermined second temporal frequency which is higher than the first temporal frequency.

10. A method according to claim 9 wherein the predetermined first temporal frequency is between approximately 0.4 Hz and 4 Hz and/or the second predetermined temporal frequency is between approximately 1 kHz and 10 kHz.

11. A receiving apparatus comprising:
at least one image sensor;
control circuitry adapted to control a frame rate of image capture by at least one image sensor;
a data processing module having a first mode of operation and a second mode of operation, wherein:
in the first mode of operation, the data processing module is adapted to process image data received from at least one image sensor which is controlled to capture images at a first frame rate and to identify, within at least one image, an image sub-region as comprising an optical data transmission signal; and
in the second mode of operation, the data processing module is adapted to process image data relating to the image sub-region received from at least one image sensor which is controlled to capture images at a second frame rate to determine a data content of the optical data transmission signal.

12. A receiving apparatus as claimed in claim 11, wherein, in the second mode of operation, the data processing module is to process an image sub-region identified in the first mode of operation and to disregard at least one other image portion.

13. A receiving apparatus as claimed in claim 11 wherein, in the first mode of operation, the data processing module is to process a plurality of images captured at the first frame rate, and to identify the image sub-region as comprising an optical data signal having a signal transmission period and a non-transmission period.

14. A receiving apparatus as claimed in claim 11 in which the control circuitry is adapted to control an image sensor to capture images at the first frame rate, and, if an image sub-region comprising an optical data transmission signal is identified by the data processing module operating in the first mode of operation, the control circuitry is adapted to control the image sensor to capture images at the second frame rate, wherein the second frame rate is higher than the first frame rate, and to control the data processing module to operate in the second mode of operation.

15. A receiving apparatus as claimed in claim 11 in which the data processing module is adapted to determine a bearing to a source of the optical data transmission signal.

16. A receiving apparatus as claimed in claim 11, wherein at least one image sensor comprises a plurality of imaging pixels, and is arranged such that the signal from each imaging pixel is read individually.

17. A receiving apparatus as claimed in claim 11 which is operatively associated with an apparatus, wherein the control circuitry is adapted to control at least one function of the apparatus based on the optical data transmission signal.

18. A transmitter comprising:
an optical source for generating an optical data signal; and
a controller adapted to control the optical source to transmit an optical data signal in a plurality of temporally separated transmission periods having a first predetermined temporal frequency, such that, in each transmission period, a series of optical pulses is transmitted, wherein the optical pulses encode data at a second predetermined temporal frequency.

19. A transmitter according to claim 18 wherein the first predetermined temporal frequency is between approximately 0.4 Hz and 4 Hz and/or the second predetermined temporal frequency is between approximately 1 kHz and 10 kHz.

20. A transmitter according to claim 18 in which the optical source comprises an infrared optical source, a visible light optical source, or an ultraviolet optical source.

21. A system comprising at least one receiving apparatus according to claim 11 and at least one optical data signal transmitter.

22. An unmanned aerial vehicle comprising at least one of a receiving apparatus according to claim 11 and an optical data signal transmitter.

23. An autonomous vehicle comprising at least one of a receiving apparatus according to claim 11 and an optical data signal transmitter.
